(19) United States
(12) Patent Application Publication
(10) Pub. No.: US 2023/0256962 A1
(43) Pub. Date: Aug. 17, 2023

(54) OBJECT CHARACTERISTIC DETERMINING DEVICE

(71) Applicant: Mitsubishi Electric Corporation, Tokyo (JP)

(72) Inventors: Masahiko KATAYAMA, Tokyo (JP); Tetsuji Haga, Tokyo (JP); Takuya Taniguchi, Tokyo (JP)

(73) Assignee: Mitsubishi Electric Corporation, Tokyo (JP)

(21) Appl. No.: 18/153,722

(22) Filed: Jan. 12, 2023

(30) Foreign Application Priority Data
Feb. 16, 2022 (JP) 2022-021734

(51) Int. Cl. B60W 30/09; G06V 20/58; G06V 20/59; B60W 40/10

(52) U.S. Cl. CPC B60W 30/09; G06V 20/58; G06V 20/597; B60W 40/10; B60W 2554/404

(57) ABSTRACT

The object characteristic determining device according to this application includes: an object position-information acquisition unit to acquire position information of an object on a road; a stop time calculation unit to calculate a stop time during which the object continues to stop, on the basis of the position information of the object acquired by the object position-information acquisition unit; an object characteristic determination unit to determine that a characteristic of the object is dynamic when the stop time calculated by the stop time calculation unit is less than a predetermined determination time, and determine that the characteristic of the object is semi-dynamic, meaning that its mobility is less than the mobility of the object that is dynamic, when the stop time is not less than the determination time; and an output unit to output a determination result determined by the object characteristic determination unit.

### TECHNICAL FIELD

The present application relates to an object characteristic determining device.

### BACKGROUND

Attention has been drawn to a technique in which vehicles and obstacles are detected by use of an object detection sensor and the detection result is applied to automatic driving or safe driving support of vehicles. As a common way to sustain automatic driving and safe driving support of vehicles, it is important to establish a dynamic map and to update and manage the dynamic map. The dynamic map is established in such a manner that information related to objects such as vehicles, obstacles, humans on the roads, which is to be included in the dynamic map, is classified into dynamic information and semi-dynamic information, and on these sets of information, semi-static information and static information are superimposed.

There is disclosed a technique in which, in order to establish the dynamic map, a traffic regulation zone is informed as semi-static information by using road cones that transmit their own positions (for example, Patent Document 1).

### CITATION LIST

### Patent Literature

Patent Document 1: Japanese Patent Application Laid-open No. 2018-159977

According to the technique disclosed in Patent Document 1, a child device for data communication is provided on each of the road cones that indicate a zone subject to traffic regulation because of construction work or the like. Coordinate positions where the respective child devices are placed are transmitted from these child devices to a parent device. Then, the respective positions of the road cones are transferred from the parent device to an on-vehicle device, so that the semi-static information of the dynamic map can be updated. This makes it possible to properly perform automatic driving even if the semi-static information changes.

However, according to the technique described in Patent Document 1, when an object on a road is detected by use of the sensor, it is not able to determine whether the information of the object is dynamic information or semi-dynamic information. For automatic driving or safe driving support of vehicles, it is important to detect an object on the road and, at the same time, to determine the characteristic of that object. When such a characteristic of the object that indicates whether the object is a dynamic object or semi-dynamic object is determined, it is possible to incorporate the information of that object in the dynamic map.

### SUMMARY

A purpose of this application is to provide an object characteristic determining device which, when having detected an object on a road by use of a sensor, can determine whether the characteristic of that object is dynamic or semi-dynamic.

### Solution to Problem

An object characteristic determining device according to this application comprises:

an object position-information acquisition unit for acquiring position information of an object on a road;

a stop time calculation unit for calculating a stop time during which the object continues to stop, on the basis of the position information of the object acquired by the object position-information acquisition unit;

an object characteristic determination unit for determining that a characteristic of the object is dynamic when the stop time calculated by the stop time calculation unit is less than a predetermined determination time, and determining that the characteristic of the object is semi-dynamic, meaning that its mobility is less than a mobility of the object that is dynamic, when the stop time is not less than the determination time; and

an output unit for outputting a determination result determined by the object characteristic determination unit.

### Advantageous Effects

By the object characteristic determining device according to this application, when it has detected an object on a road by use of a sensor, whether the characteristic of that object is dynamic or semi-dynamic can be determined.

### BRIEF DESCRIPTION OF DRAWINGS

FIG. 1 is a configuration diagram of an object characteristic determining device according to Embodiment 1.

FIG. 2 is a hardware configuration diagram of the object characteristic determining device according to Embodiment 1.

FIG. 3 is a flowchart showing object detection processing by the object characteristic determining device according to Embodiment 1.

FIG. 4 is a flowchart showing stop-time calculation processing by the object characteristic determining device according to Embodiment 1.

FIG. 5 is a flowchart showing object-characteristic determination processing by the object characteristic determining device according to Embodiment 1.

FIG. 6 is a configuration diagram of an object characteristic determining device according to Embodiment 2.

FIG. 7 is a first flowchart for showing object detection processing by the object characteristic determining device according to Embodiment 2.

FIG. 8 is a second flowchart for showing the object detection processing by the object characteristic determining device according to Embodiment 2.

FIG. 9 is a first flowchart for showing stop-time calculation processing by the object characteristic determination device according to Embodiment 2.

FIG. 10 is a second flowchart for showing the stop-time calculation processing by the object characteristic determination device according to Embodiment 2.

FIG. 11 is a first flowchart for showing object-characteristic determination processing by the object characteristic determining device according to Embodiment 2.

FIG. 12 is a second flowchart for showing the object-characteristic determination processing by the object characteristic determining device according to Embodiment 2.

FIG. 13 is a configuration diagram of an object characteristic determining device according to Embodiment 3.

FIG. 14 is a first flowchart for showing object detection processing by the object characteristic determining device according to Embodiment 3.

FIG. 15 is a second flowchart for showing the object detection processing by the object characteristic determining device according to Embodiment 3.

FIG. 16 is a first flowchart for showing object-characteristic determination processing by the object characteristic determining device according to Embodiment 3.

FIG. 17 is a second flowchart for showing the object-characteristic determination processing by the object characteristic determining device according to Embodiment 3.

### DESCRIPTION OF EMBODIMENTS

### 1. Embodiment 1

<Function Blocks of Object Characteristic Determining Device>

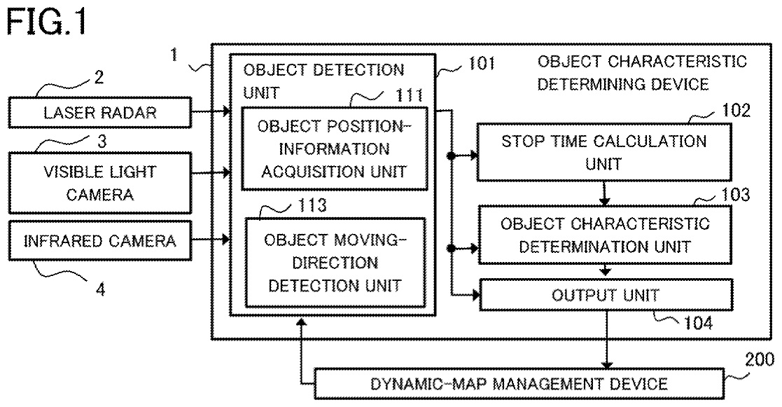

FIG. 1 is a configuration diagram showing function blocks of an object characteristic determining device 1 according to Embodiment 1. In order to detect a position, a speed, a moving direction, etc. of an object placed on a road (hereinafter, also referred to as “physical object”), the object characteristic determining device 1 is connected to a laser radar 2, a visible light camera 3 and an infrared camera 4.

The laser radar 2 is a device that irradiates a physical object with laser light and then receives reflected light of the laser light. The laser radar 2 outputs detection signals about the reflected light of the laser light to an object detection unit 101 in the object characteristic determining device 1. The object detection unit 101 calculates the position, speed, moving direction, etc. of the physical object placed on a road, on the basis of the detection signals.

The “physical object” as herein referred to is a three-dimensional object located on a road. Further, the laser radar 2 and the object detection unit 101 detect the position of a physical object that is different in height from the road surface, more specifically, the position of a three-dimensional object having a specified range of height.

The visible light camera 3 is a visible-light imaging device for capturing an image of the physical object on the road. The visible light camera 3 captures the image every fixed period of time (for example, 30 times per second), and outputs information of the thus-captured visible-light image to the object detection unit 101 in the object characteristic determining device 1. The object detection unit 101 calculates the position, speed, moving direction, etc. of the physical object placed on the road, from the information of the captured visible-light image.

The infrared camera 4 is an infrared imaging device for capturing an image of the physical object on the road, and captures the image every fixed period of time (for example, 10 times per second), and outputs information of the thus-captured infrared image to the object detection unit 101 in the object characteristic determining device 1. The object detection unit 101 calculates the position, speed, moving direction, etc. of the physical object placed on the road, from the information of the captured infrared image.

The object characteristic determining device 1 employs such laser radar 2, visible light camera 3 and infrared camera 4 that are each a sensor for detecting an object on a road, to thereby detect a vehicle and an obstacle while complementing and cross-checking the detection results. A vehicle in traveling, a vehicle in stopping, or an obstacle such as a fallen object, a pedestrian, an animal, a signboard for traffic regulation, a road cone, soil covering a road, a collapsed building or the like, is assumed as a physical object on a road. These sensors may be substituted with an LiDAR (Light Detection And Ranging) sensor that detects a direction and a distance to an object by using light, another type of radar (for example, a millimeter-wave radar) that detects a direction and a distance to a surrounding object by using an electric wave, an ultrasonic sensor that detects a distance to a short-range object, and the like. Instead, such a sensor may be added to the above sensors.

The object detection unit 101 in the object characteristic determining device 1 generates point group information, contour information, etc. on the basis of the signals from the laser radar 2, the visible light camera 3 and the infrared camera 4, to thereby identify the physical object on the road and then assign an ID thereto. The object detection unit 101 in the object characteristic determining device 1 has an object position-information acquisition unit 111 and an object moving-direction detection unit 113. The object position-information acquisition unit 111 acquires the position information of the physical object, and the object moving-direction detection unit 113 detects the moving direction of the physical object.

From the position of the physical object acquired by the object position-information acquisition unit 111 and the moving direction of the physical object detected by the object moving-direction detection unit 113, a stop time during which the physical object stops is calculated by a stop time calculation unit 102. Then, whether the characteristic of the physical object is dynamic or semi-dynamic is determined on the basis of the stop time by an object characteristic determination unit 103.

Here, whether the characteristic of the physical object is dynamic or semi-dynamic, is equivalent to whether the information of the physical object is handled as dynamic information or semi-dynamic information in the information of a dynamic map. A phrase of “whether the attribution of the physical object is dynamic or semi-dynamic” may also be used. After the determination of the characteristic of the physical object, an output unit 104 outputs the ID, position, moving direction and speed of the physical object and the characteristic of the physical object, to a dynamic-map management device 200.

The dynamic-map management device 200 uses the information of the ID, position, moving direction and speed of the physical object on the road and the characteristic of the physical object, that is received from the object characteristic determining device 1, to thereby update the dynamic map. Accordingly, the dynamic-map management device 200 can deliver an up-to-the-minute dynamic map for the purpose of automatic driving or safe driving support of vehicles.

The dynamic-map management device 200 delivers information of a road map such as a highly accurate three-dimensional map, and already-detected information about a vehicle, a human, an obstacle, a traffic regulation situation, etc., to the object detection unit 101. By the use of these sets of information, the reliability of detecting a physical object on a road by the object detection unit 101 can be improved.

<Hardware Configuration of Object Characteristic Determining Device>

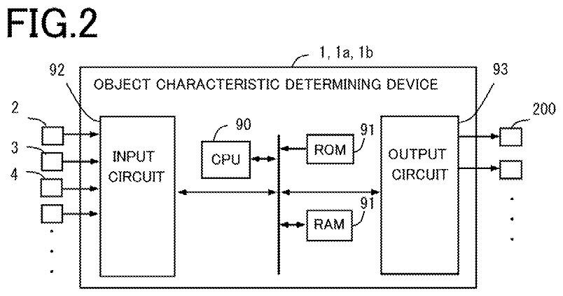

FIG. 2 is a hardware configuration diagram of the object characteristic determining device 1. Although the hardware configuration diagram of FIG. 2 may also be applied to object characteristic determining devices 1a, 1b to be described later, in the following, description will be made about the object characteristic determining device 1 as a representative. In this Embodiment, the object characteristic determining device 1 is an electronic control device for determining a characteristic of an on-road object that indicates whether the object is a dynamic object or semi-dynamic object, and then outputting the determination result. The respective functions of the object characteristic determining device 1 are implemented by a processing circuit included in the object characteristic determining device 1. Specifically, the object characteristic determining device 1 includes as the processing circuit: an arithmetic processing device 90 (computer) such as a CPU (Central Processing Unit) or the like; storage devices 91 for performing data transactions with the arithmetic processing device 90; an input circuit 92 for inputting external signals to the arithmetic processing device 90; an output circuit 93 for externally outputting signals from the arithmetic processing device 90; and the like.

As the arithmetic processing device 90, there may be included an ASIC (Application Specific Integrated Circuit), an IC (Integrated Circuit), a DSP (Digital Signal Processor), an FPGA (Field Programmable Gate Array), any one of a variety of logic circuits, any one of a variety of signal processing circuits, or the like.

Further, multiple arithmetic processing devices 90 of the same type or different types may be included so that the respective parts of processing are executed in a shared manner. As the storage devices 91, there are included a RAM (Random Access Memory) that is configured to allow reading and writing of data by the arithmetic processing device 90, a ROM (Read Only Memory) that is configured to allow reading of data by the arithmetic processing device 90, and the like. As the storage device 91, a non-volatile or volatile semiconductor memory, such as a flash memory, an EPROM, an EEPROM or the like, may be used. The input circuit 92 includes A-D converters, a communication circuit, etc. to which output signals of a variety of sensors and switches including the laser radar 2, the visible light camera 3, the infrared camera 4, and a communication line, are connected, and which serve to input these output signals of the sensors and switches, and communication information, to the arithmetic processing device 90. The output circuit 93 includes a driver circuit, a communication circuit, etc. for outputting control signals from the arithmetic processing device 90 to a device including the dynamic-map management device 200.

The respective functions that the object characteristic determining device 1 includes, are implemented in such a manner that the arithmetic processing device 90 executes software (programs) stored in the storage device 91 such as the ROM or the like, to thereby cooperate with the other hardware in the object characteristic determining device 1, such as the other storage device 91, the input circuit 92, the output circuit 93, etc. Note that the set data of threshold values, determinative values, etc. to be used by the object characteristic determining device 1 is stored, as a part of the software (programs), in the storage device 91 such as the ROM or the like. Although each of the functions that the object characteristic determining device 1 has, may be established by a software module, it may be established by a combination of software and hardware.

<Dynamic Map>

The dynamic map is an aggregation of data in which static map information and dynamic information are superimposed together. In the traffic field, the static map information is a road map and the dynamic information means information coming from an on-vehicle sensor mounted on a vehicle, a roadside sensor, a traffic light, etc. When these sets of information are delivered in a superimposed manner, it is possible to easily recognize phenomena that may occur on the road.

In the international standardization activities (ISO/TC204/WG3), discussions have been made about the concept and definition of a dynamic map. Four attributions of dynamic information, semi-dynamic information, semi-static information and static information are proposed as information of the dynamic map.

The dynamic information is information indicative of a case where a physical object is moving or, even if it is at a constant position, the position/attribution update cycle is short. The semi-dynamic information is information indicative of a target phenomenon that is not constant and thus temporally changes in its location, area and appearance time, examples of which include a traffic jam situation, a traffic obstruction situation due to traffic regulation, fallen object or accident car, and an accident itself, etc. The semi-static information is information indicative of a target phenomenon whose location, area and appearance time are planned or predicted beforehand. Further, the static information is information about a road, an on-road structure, etc., which is represented by a high accurate three-dimensional map or the like.

By identifying the physical object on the road and outputting information of the position, moving direction and speed of the physical object and the characteristic thereof, the object characteristic determining device 1 can contribute to achieving an up-to-the-minute dynamic map. Accordingly, by utilizing such a dynamic map, it is possible to achieve improvement in the reliability of automatic driving and safe driving support of vehicles.

<Object Detection Processing>

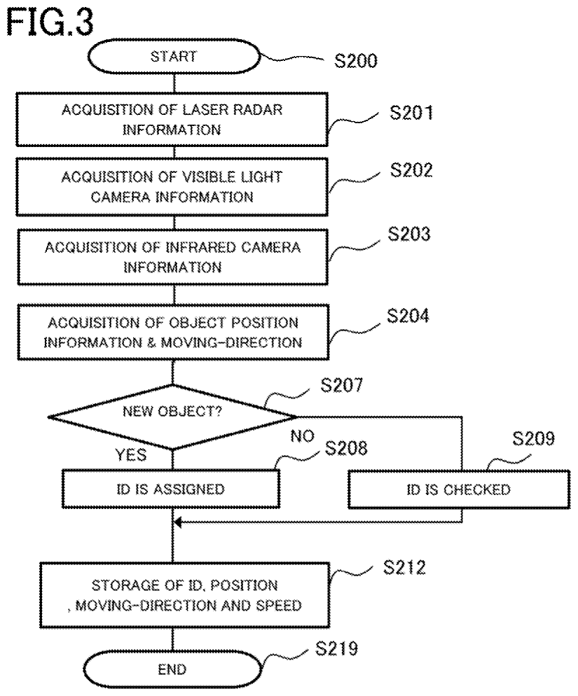

FIG. 3 is a flowchart showing object detection processing by the object characteristic determining device 1 according to Embodiment 1. The processing shown in FIG. 3 is executed every fixed period of time (for example, every 50 ms). It is allowed that the processing shown in FIG. 3 is not executed every fixed period of time but executed at every occurrence of a specified event, such as, at every signal input from the vehicle speed sensor of the vehicle, or at every receipt of an image captured by the camera. How the processing shown in the flowchart of FIG. 3 is executed by the object characteristic determining device 1 will be described below.

The processing is started from Step S200 and then, in Step S201, the object detection unit 101 acquires from the laser radar 2, detection signals of reflected light of the laser light received by that laser radar, as laser radar information. In Step S202, the object detection unit 101 acquires from the visible light camera 3, a captured visible-light image about the physical object, as visible-light camera information. In Step S203, the object detection unit 101 acquires from the infrared camera 4, a captured infrared image about the physical object, as infrared camera information.

In Step S204, the object detection unit 101 complements and cross-checks the respective sets of information acquired from the laser radar 2, the visible light camera 3 and the infrared camera 4. Further, the object position-information acquisition unit 111 acquires the position information of the physical object, and the object moving-direction detection unit 113 detects the moving direction of the physical object. When the position is checked periodically for every physical object, it is possible to calculate a moved distance, a moving speed and a moving direction of the physical object. Because the information acquired from such a sensor contains a certain error, the position information of the physical object also has an error.

In Step S207, whether or not the detected physical object is a newly detected object is determined. If it is a newly detected object (judgement is “YES”), the flow moves to Step S208 and thus an ID is assigned to the physical object, and then the flow moves to Step S212. If it is not a newly detected object (judgement is “NO”), the flow moves to Step S209, so that the ID of the physical object is checked. In this case, information about the past position, speed, moving direction, type, etc. of the physical object have already been acquired. Then, the flow moves to Step S212.

In Step S212, the ID about the physical object and the information of its latest position, moving direction and speed are stored. Thereafter, the processing is terminated at Step S219. In FIG. 3, although the processing is exemplified for one physical object, the processing is executed for all detected physical objects.

<Stop-Time Calculation Processing>

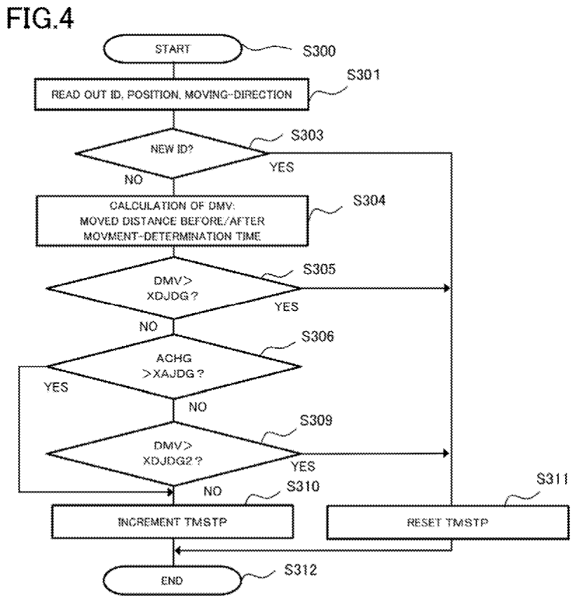

FIG. 4 is a flowchart showing stop-time calculation processing by the object characteristic determining device 1 according to Embodiment 1. The processing shown in FIG. 4 is executed every fixed period of time (for example, every 50 ms). Like the processing shown in FIG. 3, it is allowed that the processing shown in FIG. 4 is not executed every fixed period of time but executed at every occurrence of a specified event, such as, at every signal input from the vehicle speed sensor of the vehicle, or at every receipt of an image captured by the camera. How the processing shown in the flowchart of FIG. 4 is executed will be described below.

The processing is started from Step S300 and then, in Step S301, the ID of the physical object and the information of the latest position and moving direction thereof, that have been stored in the object detection processing, are read out. Then, in Step S303, whether or not the ID of the physical object is a new ID that has just been assigned. If it is a new ID (judgement is “YES”), the flow moves to Step S311 and thus a stop-time timer TMSTP is reset and thereafter, the processing is terminated at Step S312. When it is a new ID, it is meant that the physical object has just been detected, so that the timer for counting the stop time is reset and its time counting is started at that point of time.

In Step S303, if the ID of the physical object is not a new ID (judgement is “NO”), the flow moves to Step S304. In Step S304, with reference to a predetermined movement-determination time, a moved distance DMV of the physical object is calculated that is established between the object before the elapse of the movement-determination time and the object after the elapse of the movement-determination time (the movement-determination time is 1 s, for example).

In Step S305, whether or not the moved distance DMV calculated in Step S303 is larger than a predetermined determination distance XDJDG is determined (the determination distance XDJDG is 1 m, for example). If the moved distance DMV is larger than the determination distance XDJDG (judgement is “YES”), the flow moves to Step S311, so that the stop-time timer TMSTP is reset, and then the processing is terminated. This is because, since the physical object has moved, the timer for counting the stop time has to be reset. The stop time can be reset after confirming the movement of the physical object highly reliably, so that the certainty of the stop time is enhanced.

In Step S305, if the moved distance DMV is not larger than the determination distance XDJDG (judgement is “NO”), the flow moves to Step S306. Thus, whether or not a moving-direction changed angle ACHG within the predetermined determination time exceeds a predetermined angle-determination range XAJDG (30 degrees, for example) is determined.

If the moving-direction changed angle ACHG exceeds the angle-determination range XAJDG (judgement is “YES”), the flow moves to Step S310. In this case, since the change in moving direction in such a short period of time is large, it is determined that the moving direction is fluctuated due to error in detection of the position of the physical object, so that the physical object is deemed not to have moved, and thus the stop-time timer TMSTP is incremented in Step S310. Thereafter, the processing is terminated at Step S312. Accordingly, when the fluctuation occurs due to error in the position information of the physical object, it is possible to prevent the physical object from being erroneously determined to have moved.

In Step S306, if the moving-direction changed angle ACHG does not exceed the angle-determination range XAJDG (judgement is “NO”), the flow moves to Step S309.

Thus, whether or not the moved distance DMV of the physical object is larger than a predetermined second determination distance XDJDG2 (the second determination distance XDJDG2 is 50 cm, for example).

In Step S309, if the moved distance DMV of the physical object is larger than the second determination distance XDJDG2 (judgement is “YES”), the flow moves to Step S311, so that the stop-time timer TMSTP is reset. This is because the moving direction is not fluctuated in this case and thus the object is thought to have moved for a distance that is more than the second determination distance XDJDG2, in the moving direction within a specified range.

In Step S309, if the moved distance DMV of the physical object is not larger than the second determination distance XDJDG2 (judgement is “NO”), the flow moves to Step S310, so that the stop-time timer TMSTP is incremented by a specified time. This is because the moved distance DMV of the physical object is within a margin of error and thus the physical object is thought not to have moved. When the stop-time calculation processing of FIG. 4 is executed every 50 ms, the stop-time timer TMSTP is incremented by 50 ms.

Then, the processing is terminated at Step S312. In FIG. 4, although the processing is exemplified for one physical object, the processing is executed for all detected physical objects.

<Object-Characteristic Determination Processing>

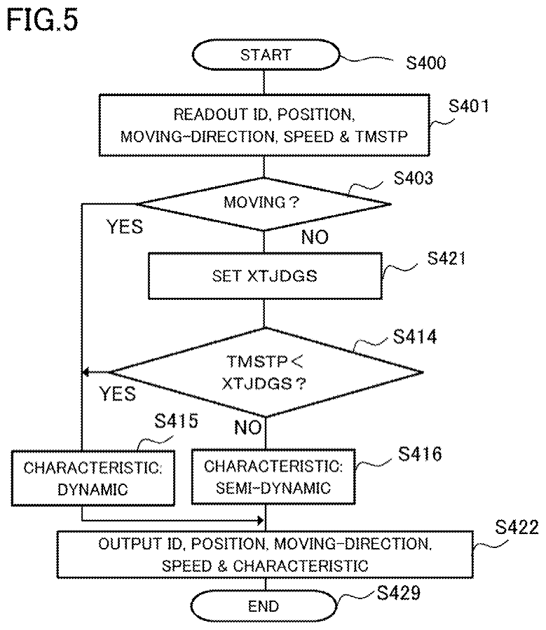

FIG. 5 is a flowchart showing object-characteristic determination processing by the object characteristic determining device 1 according to Embodiment 1. The processing shown in FIG. 5 is executed every fixed period of time (for example, every 50 ms). Like the processing shown in FIG. 3 and FIG. 4, it is allowed that the processing shown in FIG. 5 is not executed every fixed period of time but executed at every occurrence of a specified event, such as, at every signal input from the vehicle speed sensor of the vehicle, or at every receipt of an image captured by the camera. How the processing shown in the flowchart of FIG. 5 is executed will be described below.

The processing is started from Step S400 and then, in Step S401, the ID of the physical object and the information of its position, moving direction, moving speed and the stop-time timer TMSTP, are read out. Then, in Step S403, whether or not the physical object is in movement is determined. Whether or not the physical object is in movement may be determined depending on whether or not a distance between the position of the physical object detected last time and the position of the physical object detected at present, is a specified value or more. Instead, it may be determined depending on whether or not a distance between the position of the physical object at a fixed time (50 ms, for example) before and the position of the physical object detected at present, is another specified value (10 cm, for example) or more. This is to take into account the fact that the position information has an error.

In Step S403, if it is determined that the physical object is in movement (judgement is “YES”), the flow moves to Step S415. Thus, the characteristic of the object is determined to be dynamic and the flow then moves to Step S422.

In Step S403, if it is determined that the physical object is not in movement (judgement is “NO”), the flow moves to Step S421. Thus, a predetermined stop-determination time XTJDGS is set as the determination time for determining the characteristic of the object. The stop-determination time XTJDGS is a time for determining the characteristic of the physical object to be semi-dynamic when the physical object makes a stop for a time longer than that time (the stop-determination time XTJDGS is 5 s, for example). Thereafter, the flow moves to Step S414.

In Step S414, whether or not the time of the stop-time timer TMSTP is less than the stop-determination time XTJDGS is determined. If the time of the stop-time timer is less than the stop-determination time XTJDGS (judgement is “YES”), the flow moves to Step S415 and thus the characteristic of the physical object is determined to be dynamic. If the time of the stop-time timer is not less than the stop-determination time XTJDGS (judgement is “NO”), the flow moves to Step S416 and thus the characteristic of the physical object is determined to be semi-dynamic. In either case, the flow then moves to Step S422.

In Step S422, together with the ID, position, moving direction and moving speed of the physical object, the characteristic of the physical object is outputted to the dynamic-map management device 200. Accordingly, the dynamic map will be updated using up-to-the-minute information about the physical object. The processing is terminated at Step S429.

In this manner, by the object characteristic determining device 1 according to Embodiment 1, it is possible to detect a physical object on a road by use of the sensors represented by the laser radar 2, the visible light camera 3 and the infrared camera 4, and to determine whether the information of the physical object is dynamic information or semi-dynamic information. Accordingly, it is possible to update the dynamic map using the up-to-the-minute information and thus to give a contribution to the delivery of the dynamic map for the purpose of automatic driving or safe driving support of vehicles.

### 2. Embodiment 2

<Function Blocks of Object Characteristic Determining Device>

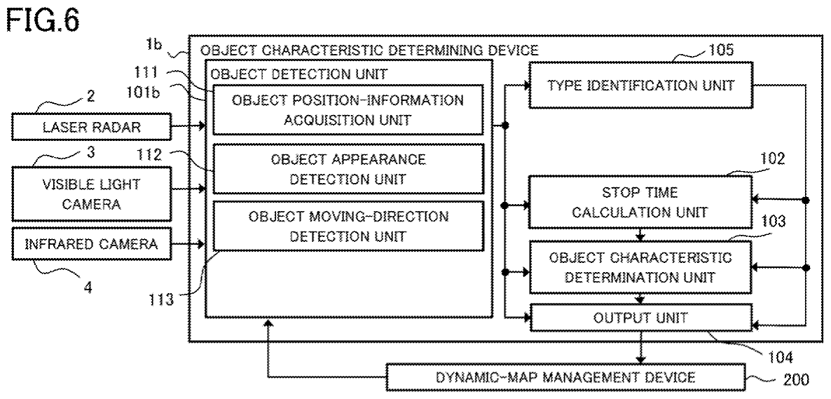

FIG. 6 is a configuration diagram showing function blocks of an object characteristic determining device 1a according to Embodiment 2. In contrast to the object characteristic determining device 1 according to Embodiment 1, an object detection unit 101a has additionally an object appearance detection unit 112. Further, the object characteristic determining device 1a has additionally a type identification unit 105 as its function block.

The object characteristic determining device 1a according to Embodiment 2 differs from the object characteristic determining device 1 according to Embodiment 1, in that it has a function of detecting the appearance of a physical object to thereby identify the type of the physical object. The type of the physical object indicates which one of a vehicle, a human, an animal, a fallen object, etc., the physical object corresponds to. Here, examples of the vehicle include a special-purpose vehicle, a four-wheel vehicle, a motorcycle, a bicycle and the like. Further, since a human or an animal moves voluntarily, its type may be classified as an autonomously movable object.

The object characteristic determining device 1a determines that the characteristic of the physical object whose type is an autonomously movable object is dynamic. This is because, even though the autonomously movable object makes a stop now, the object is assumed to suddenly go into motion voluntarily.

With respect to a physical object whose type is a vehicle, the object characteristic determining device 1a determines that the physical object continues to stop, in the case where the moved distance DMV within a specified time is smaller than the determination distance XDJDG or the moving direction is not frontward/rearward. This is because, in general, a vehicle is less conceivable to move rightward/leftward, and thus the above-mentioned case occurs due to influence of jitter (fluctuation) caused by an error in the position information of the vehicle. Accordingly, it is possible to cancel an error in the position information of the vehicle.

For a physical object whose type is a vehicle, the object characteristic determining device 1a changes the stop-determination time XTJDGS for determining the characteristic of the physical object, depending on the position at which the object exists. In the case where the vehicle is positioned on a traffic lane in a road and the vehicle makes a stop, it is possible to presume that the vehicle stops due to waiting for a traffic light or due to failure. In this case, the characteristic of the vehicle is determined by comparing the stop time of the vehicle with a predetermined roadway stop-determination time XTDL. If the stop time of the vehicle is less than the roadway stop-determination time XTDL, the object characteristic determining device 1a determines that the charact-eristic of the vehicle is dynamic. Further, if the stop time of the vehicle is not less than the roadway stop-determination time XTDL, the object characteristic determining device 1a determines that the charact-eristic of the vehicle is semi-dynamic.

The case where the vehicle is not positioned on a traffic lane in a road corresponds to a case where the vehicle is positioned on a roadside strip. When the vehicle makes a stop on the roadside strip, it is possible to presume that the vehicle is in stopping or in parking. In this case, the characteristic of the vehicle is determined by comparing the stop time of the vehicle with a predetermined roadside-strip stop-determination time XTSL. If the stop time of the vehicle is less than the roadside-strip stop-determination time XTSL, the object characteristic determining device 1a determines that the charact-eristic of the vehicle is dynamic. Further, if the stop time of the vehicle is not less than the roadside-strip stop-determination time XTSL, the object characteristic determining device 1a determines that the charact-eristic of the vehicle is semi-dynamic.

Here, the roadside-strip stop-determination time XTSL may be set to be shorter than the roadway stop-determination time XTDL. When a vehicle that is positioned on the roadside strip makes a stop, it is less likely that the vehicle takes an action that immediately affects the passage of another vehicle on the roadway. Thus, there is no problem if information of the vehicle at a stop is regarded as semi-dynamic information after such a relatively-shorter stop-determination time.

In contrast, a vehicle at a stop on a roadway is likely to take an action that immediately affects the passage of another vehicle on the roadway. Accordingly, the roadway stop-determination time XTDL should be set to be longer than the roadside-strip stop-determination time XTSL, because it has to be careful to determine the information of that vehicle to be semi-dynamic information. According to such setting, it is possible to perform determination of the characteristic of a vehicle, promptly while keeping its reliability.

<Object Detection Processing>

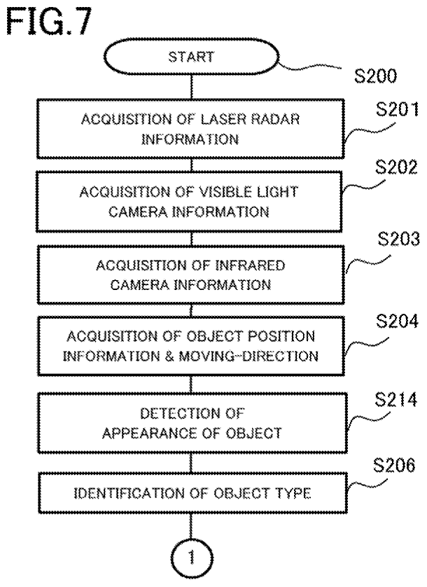

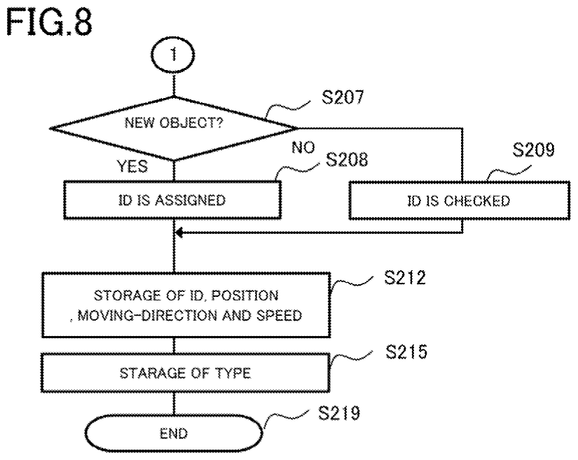

FIG. 7 is a first flowchart for showing object detection processing by the object characteristic determining device 1a according to Embodiment 2. FIG. 8 is a second flowchart for showing the object detection processing. FIG. 8 shows steps subsequent to the flowchart of FIG. 7.

The processing shown in FIG. 7 is executed every fixed period of time (for example, every 50 ms). It is allowed that the processing shown in FIG. 7 is not executed every fixed period of time but executed at every occurrence of a specified event, such as, at every signal input from the vehicle speed sensor of the vehicle, or at every receipt of an image captured by the camera. In the following, description will be made focusing on differences from the flowchart of FIG. 3 showing the object detection processing according to Embodiment 1.

In comparison to FIG. 3, the flowchart of FIG. 7 differs in that Step S214 and Step S206 are added between Step S204 and Step S207. In Step S214, the appearance of the physical object is detected. Then, in Step S206, the type of the physical object is identified on the basis of the appearance of the physical object.

In comparison to FIG. 3, the flowchart of FIG. 8 differs in that Step S215 is added between Step S212 and Step S219. In Step S215, the type of the physical object is stored. In FIG. 7 and FIG. 8, although the processing is exemplified for one physical object, the processing is executed for all detected physical objects.

<Stop-Time Calculation Processing>

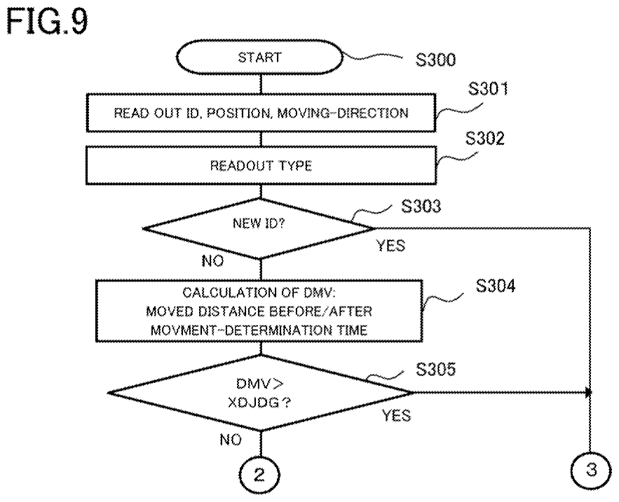

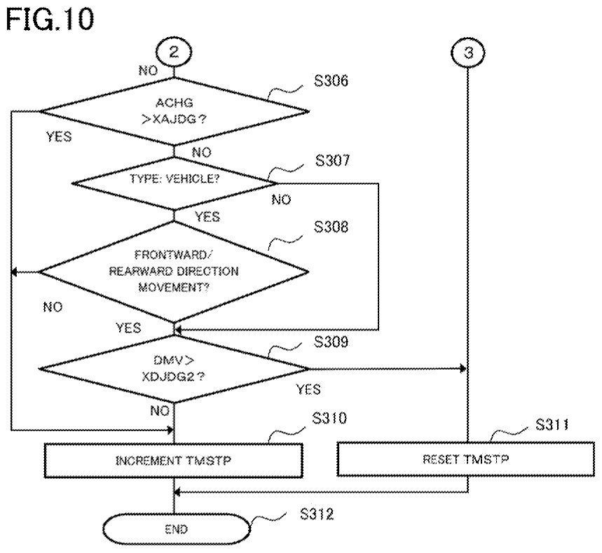

FIG. 9 is a first flowchart for showing stop-time calculation processing by the object characteristic determining device 1a according to Embodiment 2. FIG. 10 is a second flowchart for showing the stop-time calculation processing. FIG. 10 shows steps subsequent to the flowchart of FIG. 9.

The processing shown in FIG. 9 is executed every fixed period of time (for example, every 50 ms). It is allowed that the processing shown in FIG. 9 is not executed every fixed period of time but executed at every occurrence of a specified event, such as, at every signal input from the vehicle speed sensor of the vehicle, or at every receipt of an image captured by the camera. In the following, description will be made focusing on differences from the flowchart of FIG. 4 showing the stop-time calculation processing according to Embodiment 1.

In comparison to FIG. 4, the flowchart of FIG. 9 differs in that Step S302 is added after Step S301. In Step S302, the type of the physical object is read out. In comparison to FIG. 4, the flowchart of FIG. 10 differs in that Step S307 and Step S308 are added between Step S306 and Step S309. In Step S306, if the moving-direction changed angle ACHG does not exceed the angle-determination range XAJDG (judgement is “NO”), the flow moves to Step S307. In Step S307, whether or not the type of the physical object is a vehicle is determined. If the type is not a vehicle (judgment is “NO”), the flow moves to Step S310, thus resulting in the same processing as in FIG. 4.

In Step S307, if the type is a vehicle (judgement is “YES”), the flow moves to Step S308. In Step S308, whether or not the movement is directed frontward/rearward of the vehicle is determined. Specifically, when the vehicle moves in a direction within, for example, ±15 degrees with respect to the frontward/rearward direction, this movement may be determined to be the movement directed frontward/rearward of the vehicle. If the movement is directed frontward/rearward (judgement is “YES”), the flow moves to Step S309, so that, if the moved distance DMV is larger than the second determination distance XDJDG2, the stop-time timer TMSTP is reset in Step S311. Namely, it is determined that the vehicle has actually moved in the frontward/rearward direction, so that counting of the stop time is initialized.

In contrast, in Step S308, if the movement is not directed frontward/rearward (judgement is “NO”), the flow moves to Step S310, so that it is determined that the vehicle makes a stop and thus the stop-time timer TMSTP is incremented. This is because it is less conceivable that the movement of the vehicle is not directed frontward/rearward (for example, the movement is directed rightward/leftward), and thus it is conceivable that such a movement is due to influence of jitter (fluctuation) caused by an error in the position information of the vehicle.

In FIG. 9 and FIG. 10, the processing is exemplified for one physical object. However, the processing is actually executed for all detected physical objects.

<Object-Characteristic Determination Processing>

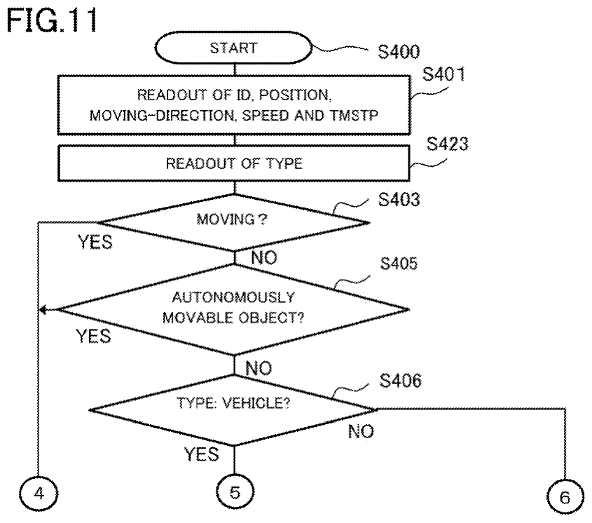

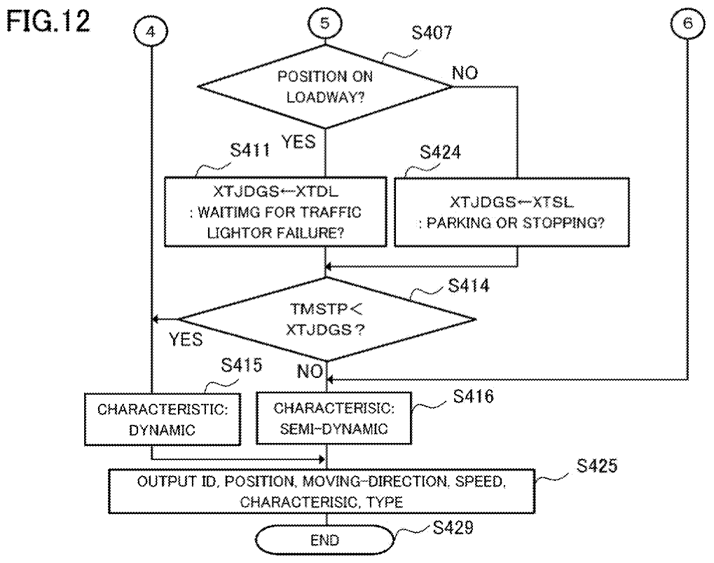

FIG. 11 is a first flowchart for showing object-characteristic determination processing by the object characteristic determining device 1a according to Embodiment 2. FIG. 12 is a second flowchart for showing the object-characteristic determination processing. FIG. 12 shows steps subsequent to the flowchart of FIG. 11.

The processing shown in FIG. 11 is executed every fixed period of time (for example, every 50 ms). It is allowed that the processing shown in FIG. 11 is not executed every fixed period of time but executed at every occurrence of a specified event, such as, at every signal input from the vehicle speed sensor of the vehicle, or at every receipt of an image captured by the camera. In the following, description will be made focusing on differences from the flowchart of FIG. 5 showing the object-characteristic determination processing according to Embodiment 1.

In comparison to FIG. 5, the flowchart of FIG. 11 differs in that Step S423 is added between Step S401 and Step S403. In Step S423, the type of the physical object is read out.

Further, in comparison to FIG. 5, in the flowcharts of FIG. 11 and FIG. 12, processing of Step S421 is substituted with processing from Step S405 to Step S407 and processing of Step S411 and Step S424.

In Step S403 in FIG. 11, if it is determined that the physical object is in movement (judgement is “YES”), like in FIG. 5, the flow moves to Step S415. In Step S403, if it is determined that the physical object is not in movement (judgement is “NO”), the flow moves to Step S405 and thus whether or not the type of the physical object is an autonomously movable object is determined. The autonomously movable object means a movable object as represented by a human and an animal, which can move or stop, freely and voluntarily. If it is determined that the physical object is an autonomously movable object (judgement is “YES”), the flow moves to S415 and thus the characteristic of the object is determined to be dynamic.

In Step S405, if it is determined that the type of the physical object is not an autonomously movable object (judgement is “NO”), the flow moves to Step S406. In Step 406, whether or not the type of the physical object is a vehicle is determined. If the type of the physical object is a vehicle (judgement is “YES”), the flow moves to Step S407. If the type is not a vehicle (judgement is “NO”), the flow moves to Step S416 and thus the characteristic of the physical object is determined to be semi-dynamic. This is because a physical object that is neither an autonomously movable object nor a vehicle is less conceivable to move.

In Step S406, if the type is a vehicle (judgement is “YES”), the flow moves to Step S407. In Step S407, whether or not the position of the physical object is on a roadway. If the position of the physical object is on a roadway (judgement is “YES”), the flow moves to Step S411 and thus the predetermined roadway stop-determination time XTDL is set as the stop-determination time XTJDGS. Since the physical object is a vehicle at a stop on a roadway, it is possible to presume that it makes a stop due to waiting for a traffic light or due to failure. Thereafter, the flow moves to Step S414.

In Step S407, if the position of the physical object is not on a roadway (judgement is “NO”), the flow moves to Step S424 and thus the predetermined roadside-strip stop-determination time XTSL is set as the stop-determination time XTJDGS. Since the physical object is a vehicle at a stop on a roadside strip, it is possible to presume that it makes a stop for parking/stopping. Thereafter, the flow moves to Step S414.

Determination processing in Step S414 is similar to that in FIG. 5, so that the description thereof is omitted here. In the following processing in FIG. 12, Step S422 in FIG. 5 is substituted with Step S425. From Step S422 in which the ID, position, moving direction, moving speed and characteristic of the physical object is outputted, Step S425 differs in that, in addition to them, the type of the physical object is outputted.

In FIG. 11 and FIG. 12, the processing is exemplified for one physical object. However, the processing is actually executed for all detected physical objects.

As described above, the object characteristic determining device 1a according to Embodiment 2 determines the characteristic of a physical object in a fine manner using processing matched to the type of the physical object. It can properly set the stop-determination time XTJDGS and determine the charact-eristic, according to the type of the physical object and the position of the physical object. Accordingly, up-to-the-minute information about a physical object confirmed on a road can be outputted to the dynamic map. This makes it possible to perform updating the dynamic map to thereby give a contribution to the delivery of the dynamic map for the purpose of automatic driving or safe driving support of vehicles.

### 3. Embodiment 3

<Function Blocks of Object Characteristic Determining Device>

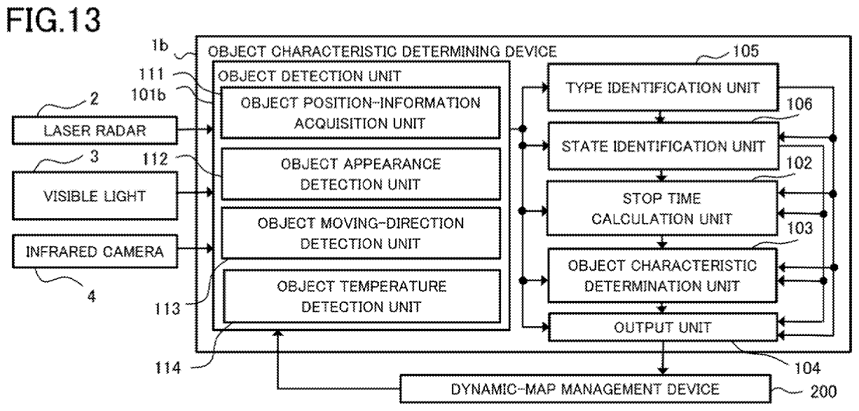

FIG. 13 is a configuration diagram showing function blocks of an object characteristic determining device 1b according to Embodiment 3. In contrast to the object characteristic determining device 1a according to Embodiment 2, an object detection unit 101b has additionally an object temperature detection unit 114. Further, the object characteristic determining device 1b has additionally a state identification unit 106 as its function block.

The object characteristic determining device 1b according to Embodiment 3 differs from the object characteristic determining device 1a according to Embodiment 2, in that the temperature of a physical object is detected by the object temperature detection unit 114 and in that it has a function of identifying the state of the physical object by using the state identification unit 106. The temperature of the physical object can be checked using the infrared camera 4. The temperature of the physical object may be detected by another method. For example, it may be detected by acquiring, through communication, output data of a temperature sensor mounted on each vehicle.

The state identification unit 106 has a function of identifying the state of the physical object on the basis of the appearance and temperature of the physical object. If the physical object is a vehicle, whether or not a rotating light of the physical object is lit is identified. In many cases, the rotating lights are mounted on vehicles of police, firefighting, public highway corporation, gas supplier and power supplier. In order to announce that the vehicle is an emergency vehicle, the rotating light is lit and brought into a rotating state. If the rotating light is being lit, the emergency vehicle is dealing with an emergency, so that it becomes highly likely that the vehicle is in parking on the site where it is to deal with the emergency.

From the appearance of the vehicle (image of the vehicle), the state identification unit 106 can identify, as a detail of the state of the vehicle, whether the driver is in a state seated on the driver seat or the driver is in a state away from the driver seat. Further, it can identify whether the engine of the vehicle is in operation or in a stopped state, by identifying the temperature of the engine room, exhaust pipe, exhaust gas or the like of the vehicle, from the image captured by the infrared camera. How to identify the state of the vehicle is not limited thereto, and such a method in which information of the sensor/sensors mounted on a vehicle is acquired may be employed.

By the object characteristic determining device 1b according to Embodiment 3, when the physical object is a vehicle, it is possible to identify as details of the state of the vehicle, a lit/unlit state of the rotating light, an operated/stopped state of the engine and an on-seat/off-seat state of the driver, to thereby utilize them for determining the characteristic of the vehicle.

If the engine of a vehicle at a stop is stopped, the vehicle is highly likely to be in parking. Further, if the rotating light is being lit or the engine is in operation, and the driver is seated on the driver seat, the vehicle is highly likely to be in stopping that is a stop within 5 minutes. If the rotating light is being lit or the engine is in operation but the driver is away from the driver seat, the vehicle is highly likely to be in parking. The stop-determination time XTJDGS for determining the characteristic of the vehicle can be set depending on these states.

In the following, discussions will be made about a magnitude relationship between an in-parking stop-determination time XTPRK that is to be set when parking of a vehicle is presumed and an in-stopping stop-determination time XTTMPSTP that is to be set when stopping of a vehicle is presumed. With respect to the state of the vehicle, if the rotating light is not lit (or no rotating light is mounted on the vehicle) and the engine is being stopped, the vehicle is less conceivable to start moving immediately. Likewise, even if the rotating light is being lit or the engine is in a rotating state, if the driver is way from the driver seat, the vehicle is less conceivable to start moving immediately.

In the case where the foregoing state of the vehicle is found, there is no problem if the characteristic of the vehicle is determined to be semi-dynamic, without setting a long confirmation time. Thus, the in-parking stop-determination time XTPRK may be set to a relatively-short period of time.

In contrast, in a state in which the rotating light is being lit or the engine is in rotation, and the driver is seated on the driver seat, there is a possibility that the vehicle starts moving immediately.

In this case, the determination that the characteristic of the vehicle is semi-dynamic should be made by setting a time enough to confirm that the vehicle is in stopping.
Thus, the in-stopping stop-determination time XTTMPSTP may be set to a relatively-long period of time.

Accordingly, the in-parking stop-determination time XTPRK to be set when parking of the vehicle is presumed, may be set to be shorter than the in-stopping stop-determination time XTTMPSTP to be set when stopping of the vehicle is presumed. Since the determination of the characteristic of the vehicle is made promptly while ensuring its reliability, it is possible to give a contribution to prompt and highly-reliable information update of the dynamic map.

<Object Detection Processing>

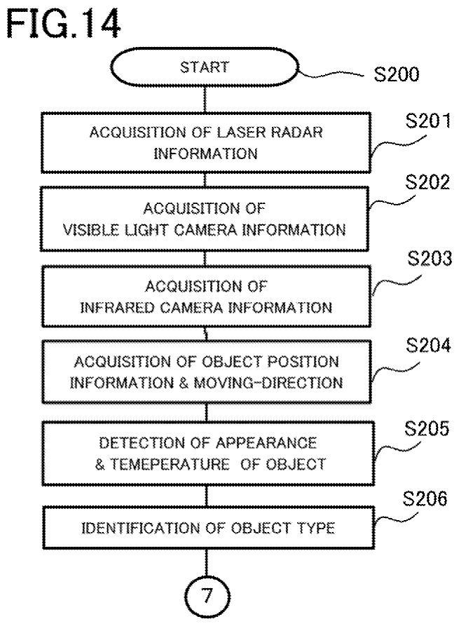

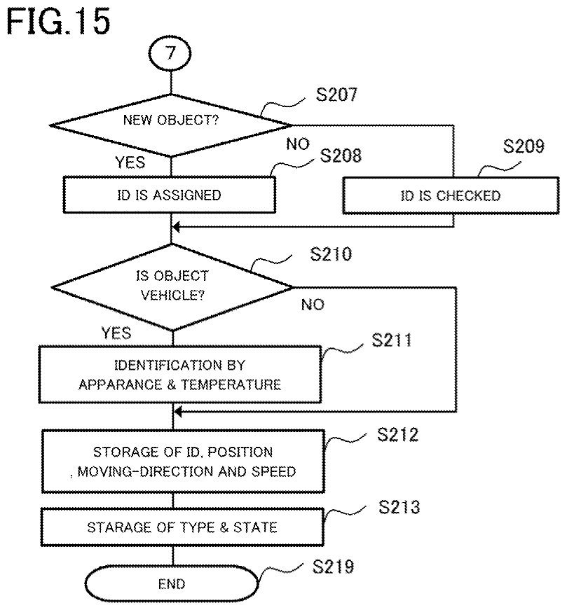

FIG. 14 is a first flowchart for showing object detection processing by the object characteristic determining device 1b according to Embodiment 3. FIG. 15 is a second flowchart for showing the object detection processing. FIG. 15 shows steps subsequent to the flowchart of FIG. 14.

The processing shown in FIG. 14 is executed every fixed period of time (for example, every 50 ms). It is allowed that the processing shown in FIG. 14 is not executed every fixed period of time but executed at every occurrence of a specified event, such as, at every signal input from the vehicle speed sensor of the vehicle, or at every receipt of an image captured by the camera. In the following, description will be made focusing on differences from the flowcharts of FIG. 7 and FIG. 8 showing the object detection processing according to Embodiment 2.

In comparison to FIG. 7, the flowchart of FIG. 14 differs in that the Step S214 is substituted with Step S205. In Step S205, not only the appearance of the physical object but also the temperature thereof is detected.

In comparison to FIG. 8, in the flowchart of FIG. 15, Step S210 and Step S211 are added prior to Step S212. Further, Step S215 is substituted with Step S213.

In Step 210, whether or not the physical object is a vehicle is determined. Whether or not the physical object is a vehicle can be confirmed from the type of the physical object. If the type of the physical object is a vehicle (judgement is “YES”), the flow moves to Step S211 and thus the state of the physical object is identified from the appearance and temperature of the physical object. Then, the flow moves to Step S212. In Step S210, if the type of the physical object is not a vehicle (judgement is “NO”), the flow skips Step S211 to move to Step S212.

In Step S212, like in FIG. 8, the ID, position, moving direction and speed of the physical object are stored. Then, in Step S213, in addition to the type of the physical object, the state of the physical object is stored. In FIG. 14 and FIG. 15, although the processing is exemplified for one physical object, the processing is executed for all detected physical objects.

<Stop-Time Calculation Processing>

The stop-time calculation processing by the object characteristic determining device 1b according to Embodiment 3 is the same as the stop-time calculation processing according to Embodiment 2. Thus, the stop-time calculation processing by the object charact-eristic determining device 1b according to Embodiment 3 is the same as the contents of FIG. 9 and FIG. 10, so that description thereof is omitted here.

<Object-Characteristic Determination Processing>

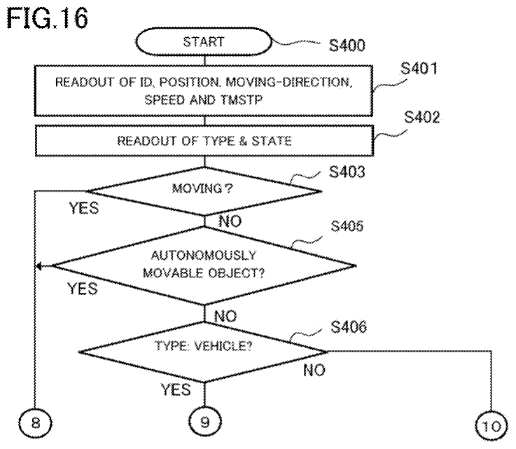

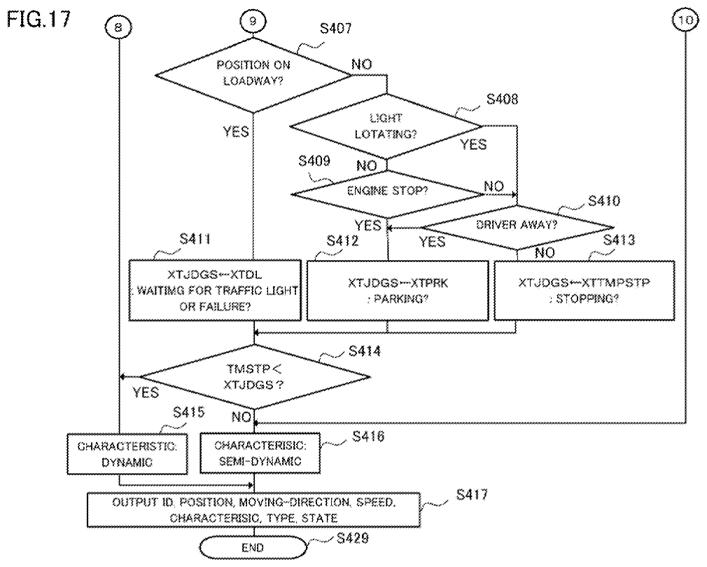

FIG. 16 is a first flowchart for showing object-characteristic determination processing by the object characteristic determining device 1b according to Embodiment 3. FIG. 17 is a second flowchart for showing the object-characteristic determination processing. FIG. 17 shows steps subsequent to the processing in FIG. 16.

The processing shown in FIG. 16 is executed every fixed period of time (for example, every 50 ms). It is allowed that the processing shown in FIG. 16 is not executed every fixed period of time but executed at every occurrence of a specified event, such as, at every signal input from the vehicle speed sensor of the vehicle, or at every receipt of an image captured by the camera. In the following, description will be made focusing on differences from the flowcharts of FIG. 11 and FIG. 12 showing the object-characteristic determination processing according to Embodiment 2.

In comparison to FIG. 11, in the flowchart of FIG. 16, Step S423 is substituted with Step S402. In Step S402, not only the type of the physical object, but also the state of the physical object is read out.

In comparison to FIG. 12, in the flowchart of FIG. 17, processing of Step S424 is substituted with processing from Step S408 to Step S410 and processing of Step S412 and Step S413. Further, Step S425 is substituted with Step S417.

In Step S407 in FIG. 17, if the position of the physical object is not on a roadway (judgement is “NO”), the flow moves to Step S408 and thus, whether or not the rotating light is being lit is determined. Whether or not the rotating light is being lit, has been identified as a detail of the state of the physical object, by the state identification unit 106. If the rotating light is being lit (judgement is “YES”), the flow moves to Step S410. If the rotating light is not being lit (judgement is “NO”), the flow moves to Step S409.

In Step S409, whether or not the engine is being stopped is determined. Whether or not the engine is being stopped, has also been identified as a detail of the state of the physical object, by the state identification unit 106. If the engine is being stopped (judgement is “YES”), the flow moves to Step S412. If the engine is not being stopped (judgement is “NO”), the flow moves to Step S410.

In Step S410, whether or not the driver is away from the driver seat of the vehicle (whether or not the driver seat is unoccupied). If the driver seat is unoccupied (determination is “YES”), the flow moves to Step S412. This is because, since the driver is away from the driver seat, parking of the vehicle is presumed. If the driver seat is not unoccupied (judgement is “NO”), the flow moves to Step S413. This is because, since the driver sits on the driver seat, the vehicle, when it is held at a stop, is presumed to be in a state of stopping.

In Step S412, parking of the vehicle is presumed, so that the in-parking stop-determination time XTPRK is set as the stop-determination time XTJDGS. Then, the flow moves to Step S414.

In Step S413, stopping of the vehicle is presumed, so that the in-stopping stop-determination time XTTMPSTP is set as the stop-determination time XTJDGS. Then, the flow moves to Step S414.

In Step S417, in addition to the ID, position, moving direction, moving speed, characteristic and type of the physical object, the state of the physical object is outputted. In FIG. 16 and FIG. 17, the processing is exemplified for one physical object. However, the processing is actually executed for all detected physical objects.

As described above, the object characteristic determining device 1b according to Embodiment 3 determines the characteristic of a physical object in a fine manner using processing matched to the type of the physical object and the state of the physical object. It can properly set the stop-determination time XTJDGS and determine the characteristic, according to the type of the physical object, the position of the physical object and the state of the physical object. Accordingly, the highly reliable and up-to-the-minute information about a physical object confirmed on a road can be outputted to the dynamic map. This makes it possible to perform updating the dynamic map in a highly reliable manner, to thereby give a contribution to the delivery of the dynamic map for the purpose of automatic driving or safe driving support of vehicles.

In this application, a variety of exemplary embodiments and examples are described; however, every characteristic, configuration or function that is described in one or more embodiments, is not limited to being applied to a specific embodiment, and may be applied singularly or in any of various combinations thereof to another embodiment. Accordingly, an infinite number of modified examples that are not exemplified here are supposed within the technical scope disclosed in the present description. For example, such cases shall be included where at least one configuration element is modified; where any configuration element is added or omitted; and furthermore, where at least one configuration element is extracted and combined with a configuration element of another embodiment.

What is claimed is:

1. An object characteristic determining device, comprising:
an object position-information acquisitor to acquire position information of an object on a road;
a stop time calculator to calculate a stop time during which the object continues to stop, on a basis of the position information of the object acquired by the object position-information acquisitor;
an object characteristic determinator to determine that a characteristic of the object is dynamic when the stop time calculated by the stop time calculator is less than a predetermined determination time, and determine that the characteristic of the object is semi-dynamic, meaning that its mobility is less than a mobility of the object that is dynamic, when the stop time is not less than the determination time; and
an output circuit to output a determination result determined by the object characteristic determinator.

2. The object characteristic determining device of claim 1, wherein, on the basis of the position information of the object acquired by the object position-information acquisitor, the stop time calculator calculates a moved distance of the object between before and after a predetermined movement-determination time, to thereby calculate the stop time on a basis of the moved distance.

3. The object characteristic determining device of claim 2, wherein the stop time calculator resets calculating the stop time when the moved distance of the object between before and after the predetermined movement-determination time is longer than a pre-determined determination distance.

4. The object characteristic determining device of claim 1, further comprising an object moving-direction detector to detect a moving direction of the object,
wherein the stop time calculator calculates the stop time on a basis of the moving direction of the object detected by the object moving-direction detector.

5. The object characteristic determining device of claim 4, wherein the stop time calculator resets calculating the stop time when, in the predetermined movement-determination time, a moving-direction changed angle of the object falls within a predetermined angle-determination range.

6. The object characteristic determining device of claim 1, further comprising:
an object appearance detector to detect an appearance of the object; and
a type identification circuit to identify a type of the object on a basis of the appearance of the object detected by the object appearance detector,
wherein, in a case where the type of the object identified by the type identification circuit is an autonomously movable object, the object characteristic determinator determines that the characteristic of the object is dynamic, and in a case where the type of the object is other than an autonomously movable object, the object characteristic determinator determines that the characteristic of the object is dynamic when the stop time is less than the determination time, and determines that the characteristic of the object is semi-dynamic when the stop time is not less than the determination time.

7. The object characteristic determining device of claim 6, wherein, when the object is a human or an animal, the type identification circuit identifies that the type is an autonomously movable object.

8. The object characteristic determining device of claim 1, comprising:
An object appearance detector to detect an appearance of the object;
an object moving-direction detector to detect a moving direction of the object; and
a type identification circuit to identify a type of the object on a basis of the appearance of the object detected by the object appearance detector,
wherein, in a case where the type of the object identified by the type identification circuit is a vehicle, the stop time calculator resets calculating the stop time when the moving direction of the vehicle detected by the object moving-direction detector is frontward or rearward of the vehicle.

9. The object characteristic determining device of claim 1, comprising:
an object appearance detector to detect an appearance of the object;
a type identification circuit to identify a type of the object on a basis of the appearance of the object detected by the object appearance detector; and
a state identification circuit to identify a state of the object on a basis of the appearance of the object detected by the object appearance detector,
wherein, in a case where the type of the object identified by the type identification circuit is a vehicle,
the state identification circuit identifies the state of the vehicle on a basis of the appearance of the vehicle detected by the object appearance detector; and
wherein, in the case where the type of the object is a vehicle, the object characteristic determinator sets the determination time on a basis of the state of the vehicle identified by the state identification circuit.

10. The object characteristic determining device of claim 9, wherein, in a case where the type of the object is a vehicle, the object characteristic determinator sets a predetermined in-parking stop-determination time as the determination time when the state of the vehicle identified by the state identification circuit is such a state in which a rotating light on the vehicle is stopped or a driver of the vehicle is away from a driver seat, and sets a predetermined in-stopping stop-determination time as the determination time when the state of the vehicle is such a state in which the rotating light is rotating and the driver is seated on the driver seat.

11. The object characteristic determining device of claim 9, further comprising an object temperature detector to detect a temperature of the object,
wherein, in a case where the type of the object identified by the type identification circuit is a vehicle, the state identification circuit identifies the state of the vehicle on a basis of the appearance of the vehicle detected by the object appearance detector and the temperature of the vehicle detected by the object temperature detector; and
wherein, in the case where the type of the object is a vehicle, the object characteristic determinator sets a predetermined in-parking stop-determination time as the determination time when the state of the vehicle identified by the state identification circuit is such a state in which an engine of the vehicle is stopped or a driver of the vehicle is away from a driver seat, and sets a predetermined in-stopping stop-determination time as the determination time when the state of the vehicle is such a state in which the engine is operated and the driver is seated on the driver seat.

12. The object characteristic determining device of claim 10, wherein, by the object characteristic determinator, the in-parking stop-determination time is set to be longer than the in-stopping stop-determination time.

13. The object characteristic determining device of claim 1, comprising:
an object appearance detector to detect an appearance of the object; and
a type identification circuit to identify a type of the object on a basis of the appearance of the object detected by the object appearance detector,
wherein, in a case where the type of the object is a vehicle, the object characteristic determinator sets the determination time on a basis of a position of the vehicle.

14. The object characteristic determining device of claim 13, wherein, in a case where the type of the object is a vehicle, the object characteristic determinator sets a predetermined roadway stop-determination time as the determination time when the position of the vehicle is on a roadway in a road, and sets a predetermined roadside-strip stop-determination time as the determination time when the position of the vehicle is on a portion of the road other than the roadway.

15. The object characteristic determining device of claim 14, wherein, by the object characteristic determinator, the roadside-strip stop-determination time is set to be shorter than the roadway stop-determination time.
